(19) United States
(12) Patent Application Publication
(10) Pub. No.: US 2021/0166318 A1
(43) Pub. Date: Jun. 3, 2021

(54) SYSTEMS AND METHODS FOR CLIENT PROFILE-BASED SALES DECISIONS

(71) Applicant: JPMorgan Chase Bank, N.A., New York, NY (US)

(72) Inventors: John TANG, New York, NY (US); Ashleigh Ann THOMPSON, New York, NY (US); Benjamin F. SYLVESTER, III, Darien, CT (US); Weimin SUN, Livingston, NJ (US); Liqiang SU, Flanders, NJ (US); Gautam MANVAR, Millstone Township, NJ (US); Charlotte KEH, Jersey City, NJ (US); Robert J. RAPPA, Manalapan, NJ (US); Richard HWANG, Greenlawn, NY (US); Mark T. DIBATTISTA, Jackson Heights, NY (US); Alfredo TENAGLIA, Nesconset, NY (US); Niall MCINTYRE, Rolle (CH); David H. ROY, London (GB); Stephanie Falbo KENNEDY, New York, NY (US); Amir TAL, Plainview, NY (US)

(21) Appl. No.: 15/172,729

(22) Filed: Jun. 3, 2016

(51) Int. Cl. G06Q 40/06

(52) U.S. Cl. CPC G06Q 40/06

(57) ABSTRACT

The invention relates to an engine that generates client profile-based sales decisions. An embodiment of the present invention is directed to providing new insights to strengthen opportunities to provide additional services to clients. The system is directed to developing client profile-based recommendations for trade ideas. For example, the innovative engine may recommend opportunities, such as new trade ideas, to a particular client based upon the client's transaction history, as well as other data and factors. The system may generate an account profile based upon client data and use this profile to score a potential new trade idea.

### FIELD OF THE INVENTION

The invention relates generally to an engine that generates sales opportunities, and more particularly to a system and method that generates client profile-based sales decisions.

### BACKGROUND OF THE INVENTION

Private banking generally involves specialized financial services for high net worth clients. Because these clients are especially affluent with significant assets, such private banking services provide highly tailored and customized services. Private banking services are limited to more traditional forms of communication when reaching out to their clients with trade ideas and other relevant information.

Currently, the process of disseminating trade ideas from an investment company to an end client is based on an Investor's experience, intuition, and deep knowledge of a client. Given both the large number of clients and the extensive range of trading ideas produced globally, there is a need to intelligently recommend the right solutions to the right client. Because of the nature of the opportunity, recommendations need to be communicated in an effective and timely manner. Current systems rely heavily on manual processes to identify appropriate trade opportunities for clients. These systems are labor intensive and time consuming.

These and other drawbacks currently exist.

### SUMMARY OF THE INVENTION

According to one embodiment, the invention relates to a computer implemented engine that generates client profile-based sales decisions, such as transaction-centric recommendations. According to an embodiment of the present invention, the engine comprises: an interactive interface that receives user input; a database that stores and manages client transaction data; and a computer processor, coupled to the interactive interface and the database, programmed to: develop a plurality of target models, where each target model has a set of factors and corresponding weights; build account profiles by applying the plurality of target models to historical transaction data to identify a plurality of trade ideas; decompose the plurality of trade ideas based on the set of factors associated with the plurality of target modes; determine scores for each trade idea based on a factor value distribution score multiplied by a factor type weight; rank trade ideas based on the scores; and electronically transmit, via the user interface, ranked trade ideas to a user.

The system may include a specially programmed computer system comprising one or more computer processors, mobile devices, electronic storage devices, and networks.

The invention also relates to computer implemented method that generates client profile-based sales decisions, such as transaction-centric recommendations. According to an embodiment of the present invention, the method comprises the steps of: developing a plurality of target models, where each target model has a set of factors and corresponding weights; building account profiles by applying the plurality of target models to historical transaction data to identify a plurality of trade ideas; decomposing the plurality of trade ideas based on the set of factors associated with the plurality of target modes; determining scores for each trade idea based on a factor value distribution score multiplied by a factor type weight; ranking trade ideas based on the scores; and electronically transmitting, via the user interface, ranked trade ideas to a user.

The computer implemented system, method and medium described herein provide unique advantages to banking clients, according to various embodiments of the invention. The innovative system and method provide timely and relevant information to a client's portfolio. Specifically, the invention provides convenient and real-time portfolio enhancing information. Other advantages include workflow efficiency to quickly prioritize products to the right client, enhanced interactions and client relationships through analytical product matching. The invention further provides the ability to scale and provide recommendations in an automated manner. These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is an exemplary illustration of a trade matching engine, according to an embodiment of the present invention.

FIG. 2 illustrates a schematic diagram of a system is shown, according to an exemplary embodiment.

FIG. 3 is an exemplary flowchart of a train feature of a matching engine, according to an embodiment of the present invention.

FIG. 4 is an exemplary illustration of target models, according to an embodiment of the present invention.

FIG. 5 is an exemplary illustration of target model composition, according to an embodiment of the present invention.

FIG. 6 is an exemplary illustration of an account profile, according to an embodiment of the present invention.

FIG. 7 is an exemplary flowchart of a train feature of a matching engine, according to an embodiment of the present invention.

FIG. 8 is an exemplary illustration of relevant factor value distribution values for a trade idea, according to an embodiment of the present invention.

FIG. 9 is an exemplary illustration of scoring for each target model, according to an embodiment of the present invention.

FIG. 10 is an exemplary illustration of an overall recommendation score, according to an embodiment of the present invention.

FIG. 11 is an exemplary illustration of multiple trade idea scores, according to an embodiment of the present invention.

FIG. 12 is an exemplary illustration of matching engine types, according to an embodiment of the present invention.

FIG. 13 is an exemplary flowchart illustrating an overall workflow, according to an embodiment of the present invention.

FIG. 14 is an exemplary flowchart illustrating an account profile workflow, according to an embodiment of the present invention.

FIG. 15 is an exemplary flowchart illustrating an idea generation workflow, according to an embodiment of the present invention.

FIG. 16 is an exemplary flowchart illustrating a recommendation workflow, according to an embodiment of the present invention.

FIG. 17 is an exemplary flowchart illustrating a configure models workflow, according to an embodiment of the present invention.

FIG. 18 are exemplary screenshots of workflows, according to an embodiment of the present invention.

### DETAILED DESCRIPTION OF THE PREFERRED EMBODIMENT(S)

The following description is intended to convey an understanding of the present invention by providing specific embodiments and details. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

An embodiment of the present invention is directed to an engine that augments an Investors experience and allows for new insights to strengthen opportunities to provide additional services to clients. An embodiment of the present invention is directed to developing recommendations, such as a transaction-centric recommendations for trade ideas. The trade matching embodiment of the present invention may recommend new trade ideas to a particular client based upon the client's transaction history, as well as other data and factors. According to an embodiment of the present invention, the system may generate an account profile based upon the transaction history and use this profile to score a new trade idea.

The innovative system and method are directed to developing target models centered on multiple factors (or inputs) that provide unique account profiles based on the transaction history. Trade ideas may be scored against each profile, providing investors the ability to view the strength of the recommendation for a client's approval.

Another embodiment of the present invention is directed to matching algorithms available to the Investors, including recommendations based upon client similarity. The features described herein may be applied to other areas, services and/or applications where there is a strong Sales or Marketing of assets to a client. Other areas may include Consumer/Private Banking, Digital Marketing, Cross-Line of Business and Merchant opportunities. For example, in the Consumer/Private Bank application, an embodiment of the present invention may recommend credit cards, saving accounts and other products based on similar clients. For Digital Marketing, the system may extend capabilities of online web portals to effectively recommend products. For Cross-Line of Business, the system may be directed to selling of products between different clients and asset classes. For Merchants, the system may recommend placement of new branches based on customer demographic similarity. Other applications and scenarios may be implemented.

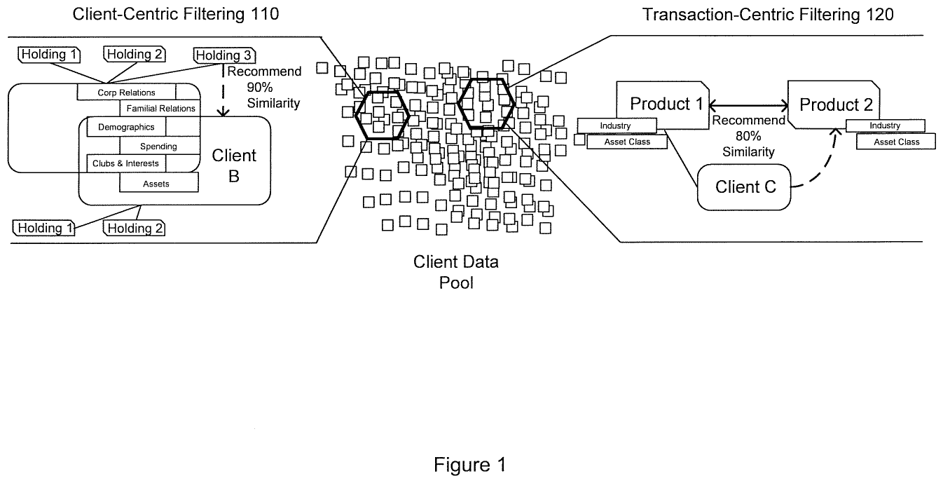

FIG. 1 is an exemplary illustration of a trade matching engine, according to an embodiment of the present invention. As shown in FIG. 1, an exemplary engine is based on the concept of similarity, which may involve similarity of clients (or users, products, etc.) and/or similarity of transactions (or other action). Client-centric recommendations act on features of interest to those like a client, though the client may have no prior demonstrated interest, while transaction-centric recommendations are influenced by past interests.

In the case of client-centric similarity, as shown by 110, an embodiment of the present invention may identify an overlap of interests based upon client demographic and other information. Given that two clients share similar interests, the engine may recommend a product to one who does not currently have the product that the other client does. For example, both Client A and Client B are in their 30s, both are employed as software engineers, and both are generally interested in trading technology stocks. Both Client A and Client B have traded in Holding 1 and Holding 2. In this example, Client A has traded heavily in Holding 3 whereas Client B has never traded in this instrument. Given the similarities between the two clients, the trade matching engine may determine that trading in Holding 3 is a good recommendation for Client B.

In the case of transaction-centric similarity, as shown by 120 recommendations may be made by extracting key features of products liked or purchased in the past by a particular client and then projecting those same (or similar) features onto unseen products. For example, by profiling some or all positions and/or transactions associated with a particular Client, it may become apparent that the Client is favorable to US technology stocks (as shown by Client C's purchase of Product 1). Therefore, a recommendation which includes US-based tech company (Product 2) would be assessed as a favorable recommendation.

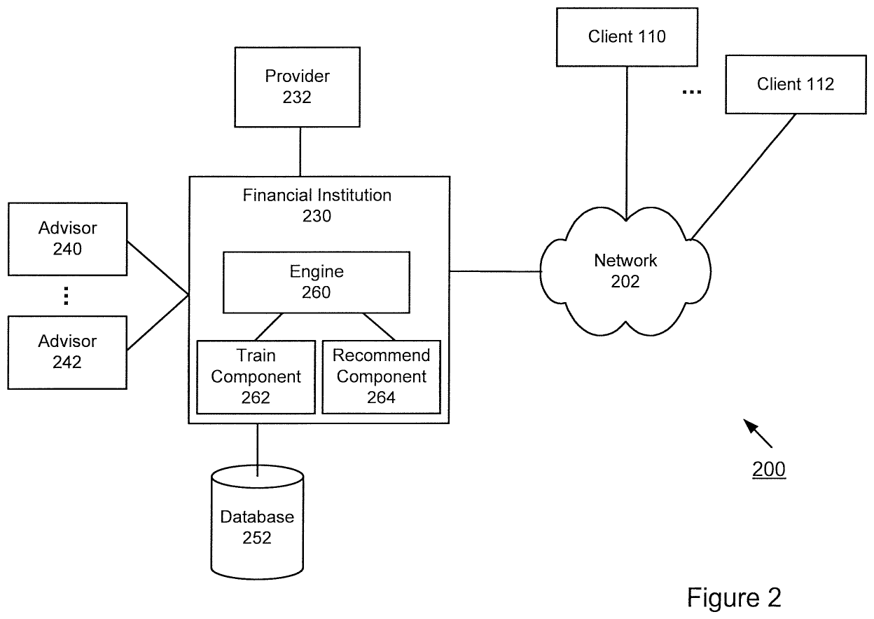

FIG. 2 illustrates a schematic diagram of a system is shown, according to an exemplary embodiment. As illustrated, network 202 may be communicatively coupled with one or more data devices including, for example, computing devices associated with clients 210, 212. Clients 210, 212 may communicate using any mobile or computing device, such as a laptop computer, a personal digital assistant, a smartphone, a smartwatch, smart glasses, other wearables or other computing devices capable of sending or receiving network signals. Client devices may have an application installed that is associated with financial institution 230. While FIG. 2 illustrates individual devices or components, it should be appreciated that there may be several of such devices to carry out the various exemplary embodiments.

In addition, Network 202 communicates with Financial Institution 230 that provides private banking services through a plurality of advisors, represented by 240, 242 and/or other analytical tools. Financial Institution 230 may include an Engine 260 that provides and generates client profile-based recommendations and opportunities to clients 210, 212 as well as advisors 240, 242 who may then communicate to clients 210, 212. Engine 226 may include an interactive user interface and other functions and components.

According to an exemplary embodiment, Engine 260 may provide trade opportunities. For example, trade ideas, factors, target models and other related data may be stored and managed by Database 252. The trade recommendation features described according to an exemplary embodiment may be provided by Financial Institution 230 and/or a third party provider, represented by 232, where Provider 232 may operate with Financial Institution 230.

Engine 260 of an embodiment of the present invention is directed to enhancing and augmenting an Investor's ability to serve clients in various ways, by offering massive scale in the number of recommendations made on a daily basis and by providing a quantitative explanation for why a particular idea should be pitched to a client.

Engine 260 may include a Train component 262 and a Recommend component 264. At the core of both of these elements is the concept of factors. A factor may be defined as a unique tuple of a factor type and a factor value. A factor type may represent an attribute of a transaction, e.g., symbol, industry, or region, and a factor value may represent a transaction-specific value associated with that attribute. For example, for a factor type may be a symbol and possible factor values may include IBM, and JPM amongst other possibilities.

Train Component 262 may create a profile that captures trading behavior of a given account. This may be achieved by defining a set of target models of interest. Each target model may include any number of factor types which may be individually weighted based upon the target model to which they belong. For each target model, a weighted frequency distribution (which may be on volume, notional value, or some other value or interest) may be generated to create an account profile. This profile may then be saved and inspected by an Investor to understand the client's accounts. Additionally, this profile may be extended to new factor types through a recalibration.

Recommend Component 264 may calculate a recommendation score (e.g., between 0 and 1) for a trade idea per account. This works by extracting the same set of target model factors types (e.g., symbol, industry, or region) from the trade idea. The frequency value for each factor of the trade idea may be extracted from the saved account profile and then multiplied by the weight as defined in the target model to calculate a final recommendation score for the account. In contrast to a binary “Recommend” or “Do Not Recommend” outcome, a recommendation score provides the ability to rank or prioritize accounts or trades to an Investor.

The system 200 of FIG. 2 may be implemented in a variety of ways. Architecture within system 200 may be implemented as hardware components (e.g., module) within one or more network elements. It should also be appreciated that architecture within system 200 may be implemented in computer executable software (e.g., on a tangible, non-transitory computer-readable medium) located within one or more network elements. Module functionality of architecture within system 200 may be located on a single device or distributed across a plurality of devices including one or more centralized servers and one or more mobile units or end user devices. The architecture depicted in system 200 is meant to be exemplary and non-limiting. For example, while connections and relationships between the elements of system 200 is depicted, it should be appreciated that other connections and relationships are possible. The system 200 described below may be used to implement the various methods herein, by way of example. Various elements of the system 100 may be referenced in explaining the exemplary methods described herein.

The network 202 may be a wireless network, a wired network or any combination of wireless network and wired network. For example, the network 202 may include one or more of an Internet network, a satellite network, a wide area network (“WAN”), a local area network (“LAN”), an ad hoc network, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11g, 802.11n, 802.11ac, or any other wired or wireless network for transmitting or receiving a data signal. Also, the network 202 may support an Internet network, a wireless communication network, a cellular network, Bluetooth, or the like, or any combination thereof. The network 202 may further include one, or any number of the exemplary types of networks mentioned above operating as a stand-alone network or in cooperation with each other. The network 202 may utilize one or more protocols of one or more network elements to which it is communicatively coupled. The network 202 may translate to or from other protocols to one or more protocols of network devices. Although the network 202 is depicted as one network for simplicity, it should be appreciated that according to one or more embodiments, the network 202 may comprise a plurality of interconnected networks, such as, for example, a service provider network, the Internet, a cellular network, corporate networks, or even home networks, or any of the types of networks mentioned above.

Data may be transmitted and received via network 202 utilizing a standard networking protocol or a standard telecommunications protocol. For example, data may be transmitted using Session Initiation Protocol (“SIP”), Wireless Application Protocol (“WAP”), Multimedia Messaging Service (“MMS”), Enhanced Messaging Service (“EMS”), Short Message Service (“SMS”), Global System for Mobile Communications (“GSM”) based systems, Code Division Multiple Access (“CDMA”) based systems, Transmission Control Protocol/Internet Protocols (“TCP/IP”), hypertext transfer protocol (“HTTP”), hypertext transfer protocol secure (“HTTPS”), real time streaming protocol (“RTSP”), or other protocols and systems suitable for transmitting and receiving data. Data may be transmitted and received wirelessly or in some cases may utilize cabled network or telecom connections such as an Ethernet RJ45/Category 5 Ethernet connection, a fiber connection, a cable connection or other wired network connection.

Financial Institution 230 may be communicatively coupled to Database 252. Database 252 may contain curated content, such as trade opportunities, portfolio impact data, thought leadership, and other data used by the system 200. For example, Database 252 may store client account data, client portfolio data, profile data, etc. Database 252 may include any suitable data structure to maintain the information and allow access and retrieval of the information. For example, Database 252 may keep the data in an organized fashion and may be an Oracle database, a Microsoft SQL Server database, a DB2 database, a MySQL database, a Sybase database, an object oriented database, a hierarchical database, a flat database, and/or another type of database as may be known in the art to store and organize data as described herein.

Database 252 may be any suitable storage device or devices. The storage may be local, remote, or a combination thereof with respect to Database 252. Database 252 may utilize a redundant array of disks (RAID), striped disks, hot spare disks, tape, disk, or other computer accessible storage. In one or more embodiments, the storage may be a storage area network (SAN), an internet small computer systems interface (iSCSI) SAN, a Fiber Channel SAN, a common Internet File System (CIFS), network attached storage (NAS), or a network file system (NFS). Database 252 may have back-up capability built-in. Communications with Database 252 may be over a network, such as network 202, or communications may involve a direct connection between Database 252 and Financial Institution 230, as depicted in FIG. 2. Database 252 may also represent cloud or other network based storage.

Having described an example of the hardware, software, and data that can be used to run the system, an example of the method and client experience will now be described. The method will be described primarily as an example in which a client downloads a software application (sometimes referred to as an “app”) and uses it to perform banking transactions and/or other functionality, including making purchases. However, those skilled in the art will appreciate that the principles of the invention can be applied to related circumstances, such as where the entity providing the app is a business other than a financial institution, or where the financial institution app functionality is provided through a browser on the client's mobile device rather than through a software application (app) downloaded to the client's mobile device, and with purchases from various providers.

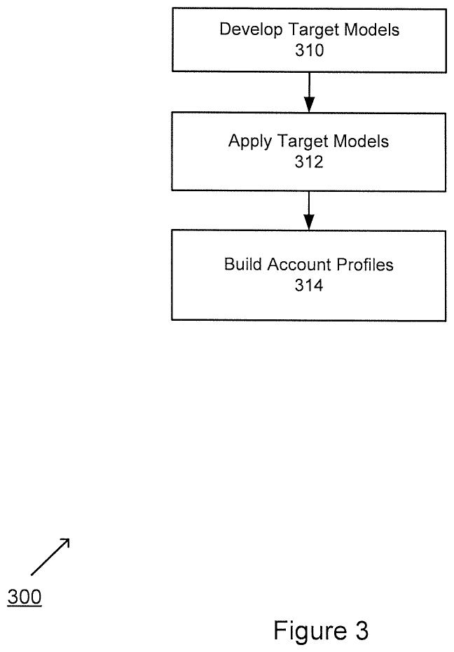

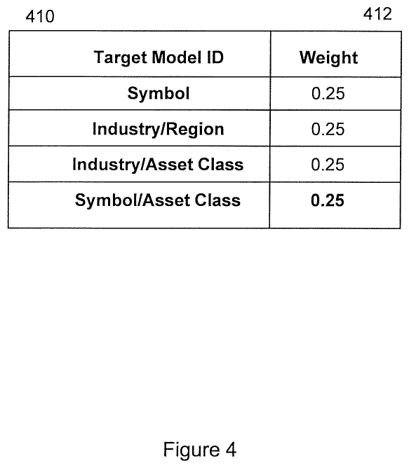

FIG. 3 is an exemplary flowchart of a train feature of a match engine, according to an embodiment of the present invention. At step 310, target models may be developed. At step 312, the target models may be applied. At step 314, account profiles may be built. The order illustrated in FIG. 3 is merely exemplary. While the process of FIG. 3 illustrates certain steps performed in a particular order, it should be understood that the embodiments of the present invention may be practiced by adding one or more steps to the processes, omitting steps within the processes and/or altering the order in which one or more steps are performed. These steps will be described in greater detail below. FIGS. 4-6 illustrate an embodiment of the present invention as applied to an example scenario for illustration purposes. The various features and functionality may be modified and applied to various scenarios, applications and environments.

At step 310, target models may be developed. FIG. 4 is an exemplary illustration of target models, according to an embodiment of the present invention. As shown in FIG. 4, Target Model identifiers may be listed at 410 and corresponding weights may be identified at 412. In this example, Target Models include Symbol, Industry/Region, Industry/Asset Class and Symbol/Asset Class. FIG. 4 illustrates an example of a configuration. In accordance with the various embodiments of the present invention, Target Model identifiers and weights shown in FIG. 4 are highly configurable based on various factors, preferences and applications as well as a feedback based mechanism. For example, the target models and weights illustrated in FIG. 4 may vary. Other forms of weighting may also be applied.

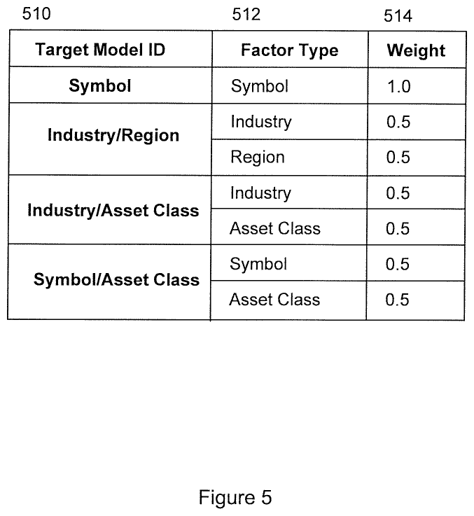

At step 312, the target models may be applied to account data. FIG. 5 is an exemplary illustration of target model composition, according to an embodiment of the present invention. For a given a time period (e.g., 1-year) of transaction history for an account, a profile may be constructed of the following target models and associated target model weights. Each target model may be composed of the following factor types and associated factor type weights. In this example, Target Model for Symbol comprises Factor type Symbol with a weight of 1.0. Target Model for Industry/Region comprises Factor Types Industry and Region, each with a weight of 0.5. Target Model for Industry/Asset Class comprises Factor Types Industry and Asset Class, each with a weight of 0.5. Target Model for Symbol/Asset Class comprises Factor Types Symbol and Asset Class, each with a weight of 0.5. FIG. 5 illustrates an example of a configuration. In accordance with the various embodiments of the present invention, Target Model identifiers, factor types and weights shown in FIG. 5 are highly configurable and may vary based on various factors, preferences and applications.

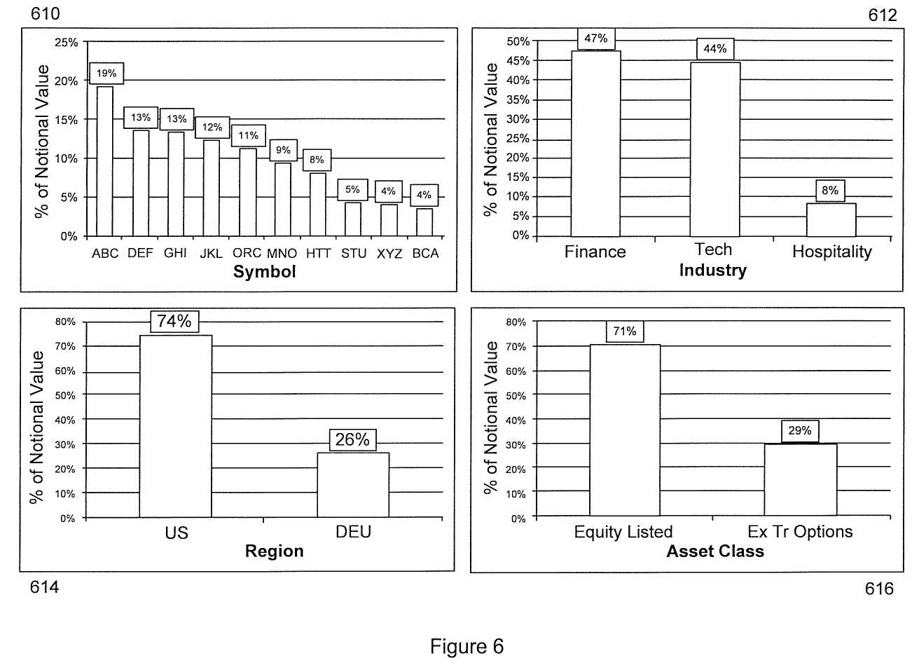

At step 314, account profiles may be built. FIG. 6 is an exemplary visualization of an account profile, according to an embodiment of the present invention. Using a numerical input parameter of notional value, the system may build a distribution of factor values for each listed factor type, generating an account profile. As shown in FIG. 6, profile distributions associated with each factor type for an account may be used to compare and contrast the transaction history of multiple accounts and provide insights to particular attributes an account may be active or interested in. For example, section 610 illustrates a profile distribution for Symbol; section 612 illustrates a distribution for Industry, e.g., Finance, Technology and Hospitality; section 614 illustrates a distribution for Region, e.g., US and DEU; and section 616 illustrates a distribution for Asset Class, e.g., equity listed and Exchange-traded options. FIG. 6 illustrates an example of a configuration. In accordance with the various embodiments of the present invention, profile distributions are highly configurable and may vary based on various factors, preferences and applications.

Under the Train component, an embodiment of the present invention may be directed to constructing an Account Profile. The Matching Engine may include high level constructs, including Factors and Target Models. Factors may represent independent categories into which trades and transactions are decomposed. Target Models may represent combinations of factor types that form separate trading themes.

According to an exemplary illustration, an account A may be composed of N-number of transactions T, each of which may include M-number of Factors. A Factor F may be defined as a unique tuple of Factor Type FT and Factor Value FV. A Factor Type may be a descriptive attribute of a transaction, such as Symbol, Country of Exposure, Industry, or Asset Class while a Factor Value is the specific value which corresponds to the Factor Type. For example, for a Factor Type of Symbol, possible Factor Values include the universe of tickers; for a Factor Type of Industry, possible Factor Values include the universe of Standard Industrial Classifications (SIC).

A=(T₁,T₂, . . . ,T_{N})

Tᵢ(A)={F₂, . . . ,F_{M}}

Fᵢⱼ=<FTᵢ,FVⱼ>

This account transaction history may be used to construct an Account Profile based upon a set of P-number of Target Models. For example, each Target Model may include a given model weight mw such that the sum of all model weights is equal to 1. A Target Model TM may include Q-number of Factor Types, with each Factor Type given a specific type weight tw such that the sum of all type weights is equal to 1. Other ranges and/or standards may be applied.

Account Profile={TM₁*mw₁,TM₂*mw₁, . . . ,TM_{P}*mw_{P}|Σᵢ₌₁^{P}mwᵢ=1}

TMᵢ={FT₁*tw₁,FT₂*tw₂, . . . ,FT_{Q}*tw_{Q}|Σⱼ₌₁^{Q}twⱼ=1}

For each Factor Type within a Target Model, a distribution of Factor Values may be built based upon a given value such as a number of executed trades or a notional value of the executed trades. For example, the weight of each entry in the distribution—XYZ Corporation as the Symbol or Transportation Services as the Industry—may represent the interest the client has shown in the entry. The distributions for Account Profiles may be represented by P_{Factor}(·). As indicated, although the current weightings are determined by transactions to date, the matching engine of an embodiment of the present invention may take into account portfolio trends, marginal contributions to risk, or other properties of interest to investors. Additionally, based upon a transaction portfolio, it may beneficial to instead include Boolean indicator variables based upon a trade idea. For example, if a client trades in over 1000 symbols, the distribution value associated with any one symbol may on average be quite small; so the actually distribution value is less meaningful than the fact that they have ever traded in the symbol.

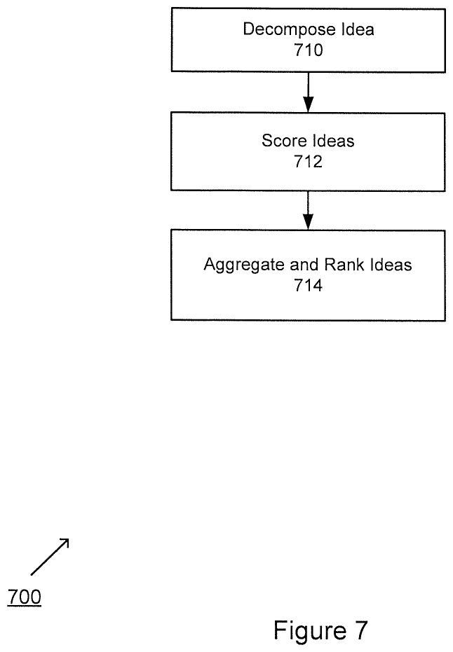

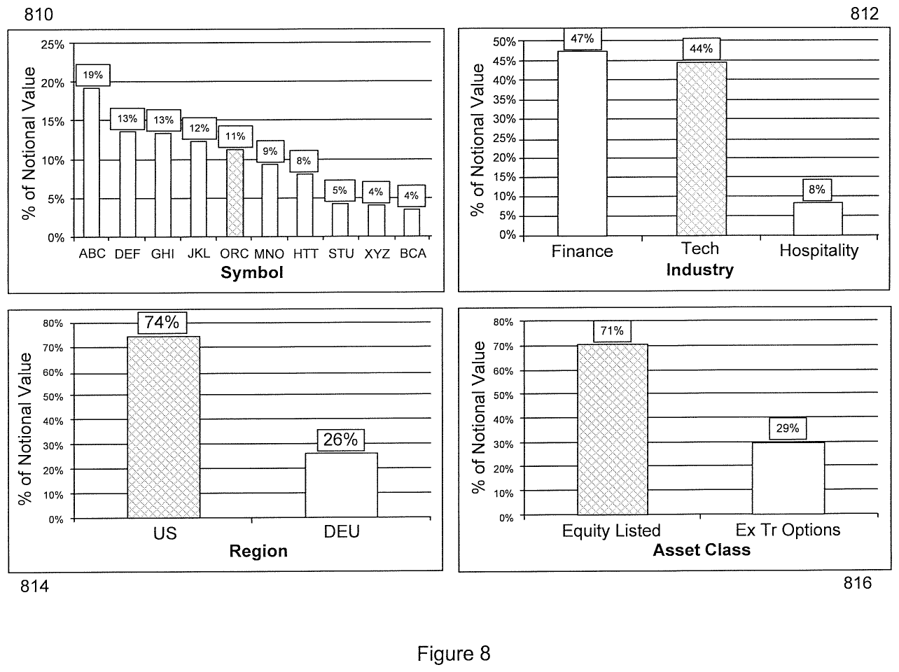

FIG. 7 is an exemplary flowchart of a train feature of a matching engine, according to an embodiment of the present invention. At step 710, an opportunity or idea may be decomposed. At step 712, the opportunities or ideas may be scored. At step 714, the opportunities or ideas may be aggregated and ranked. The order illustrated in FIG. 7 is merely exemplary. While the process of FIG. 7 illustrates certain steps performed in a particular order, it should be understood that the embodiments of the present invention may be practiced by adding one or more steps to the processes, omitting steps within the processes and/or altering the order in which one or more steps are performed. These steps will be described in greater detail below. FIGS. 8-11 illustrate an embodiment of the present invention as applied to an example scenario for illustration purposes. The various features and functionality may be modified and applied to various scenarios, applications and environments.

At step 710, an opportunity or idea may be decomposed. For example, a trade idea may be decomposed. In this example, for each trade idea, an embodiment of the present invention may decompose the idea into the same (or similar) set of factor types that were used to build the account profile to build the list of factor type and factor value tuples. For example, the idea to “Buy ORC Stocks” may be decomposed into the following: trade idea may be represented by <Symbol, ORC>, <Asset Class, Equity Listed>, <industry, Tech>, <Region, US>.

At step 712, the opportunities or ideas may be scored. For example, trade ideas may be scored. In this example, for each target model in the account profile, an embodiment of the present invention may obtain a factor value distribution score related to that component of the trade idea and multiply by a specified factor type weight to obtain the component target model score. FIG. 8 is an exemplary illustration of relevant factor value distribution values for a single trade idea, according to an embodiment of the present invention. The symbol ORC is highlighted in section 810 at 11%, section 812 at 44% in the Technology industry, section 814 at 74% in the US region and section 816 at 71% in the equity listed class. FIG. 8 illustrates an example of a configuration. In accordance with the various embodiments of the present invention, profile distributions are highly configurable and may vary based on various factors, preferences and applications.

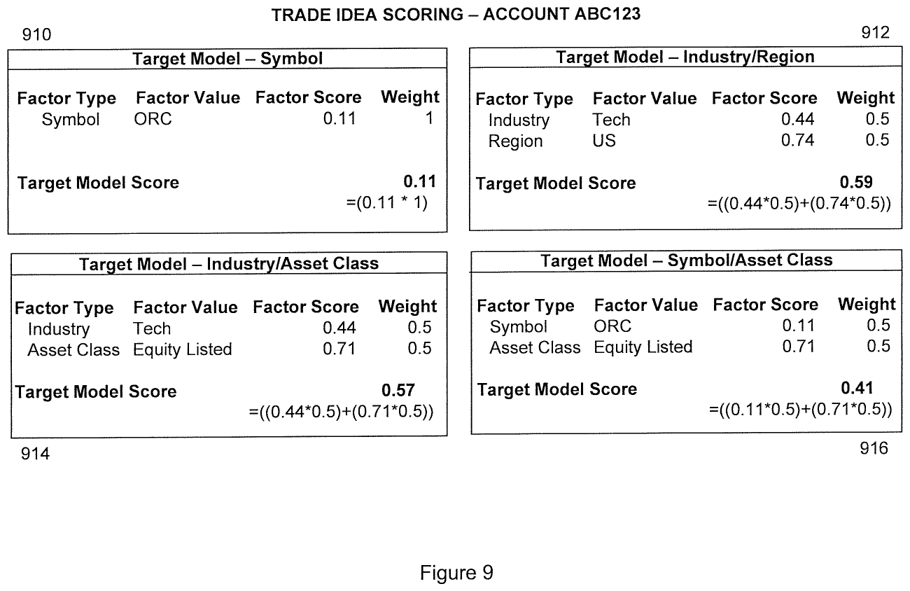

FIG. 9 is an exemplary illustration of scoring for each target model for a single trade idea, according to an embodiment of the present invention. For Target Model-Symbol, as shown at 910, a corresponding score and weight are identified for the symbol and a target model score is calculated. For Target Model-Industry/Region, as shown at 912, corresponding scores and weights are identified for Industry and Region and a target model score is calculated. For Target Model-Industry/Asset class, as shown at 914, corresponding scores and weights are identified for Industry and Asset Class and a target model score is calculated. For Target Model-Symbol/Asset Class, as shown at 916, corresponding scores and weights are identified for Symbol and Asset Class and a target model score is calculated. FIG. 9 illustrates an example of a configuration. In accordance with the various embodiments of the present invention, target models are highly configurable and may vary based on various factors, preferences and applications.

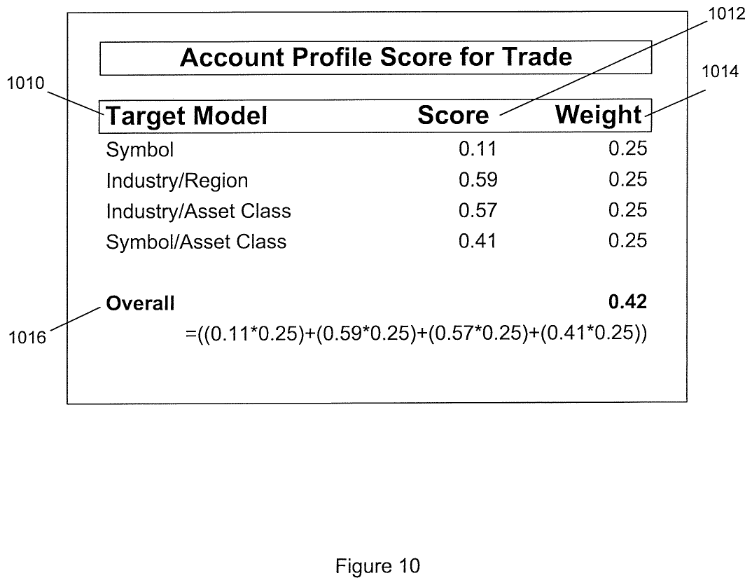

FIG. 10 is an exemplary illustration of an overall recommendation score, according to an embodiment of the present invention. Each component target model 1010 has a score 1012 that may then be multiplied by its configured weight 1010 to generate the overall account profile score for the trade idea, shown at 1016. As indicated, both factor type and target model weights may be tunable. As shown in FIG. 10, an overall score comprises each score multiplied by a corresponding weight. FIG. 10 illustrates an example of a configuration. In accordance with the various embodiments of the present invention, the target model, scores and weights are highly configurable and may vary based on various factors, preferences and applications.

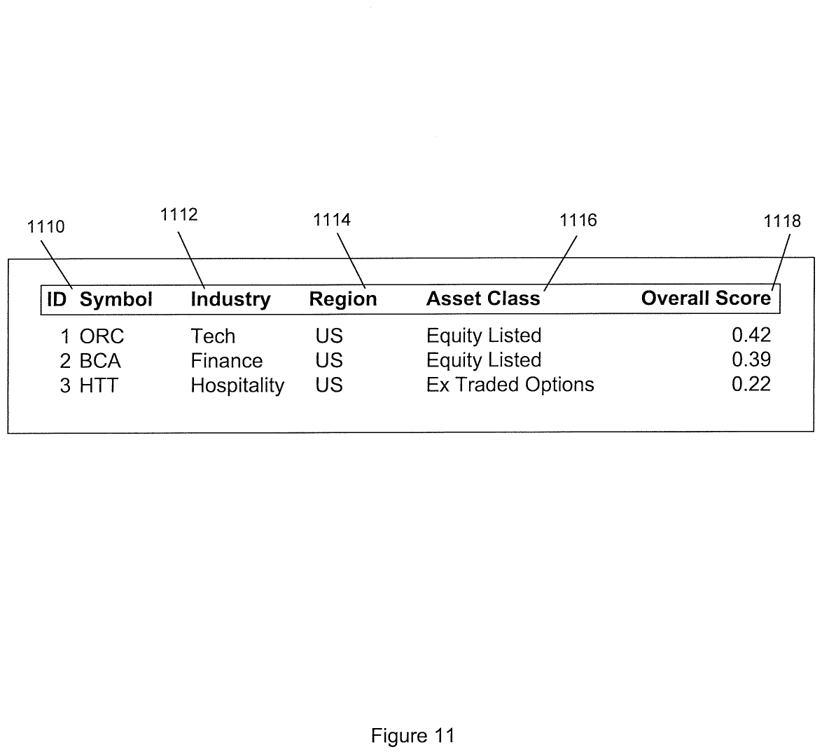

At step 714, the opportunities or ideas may be aggregated and ranked. For example, trade ideas may be aggregated and ranked. This overall account profile score may then be compared against the account profile score for the same (or similar) trade idea generated for a different account profile in order to rank all accounts' potential interest in an idea. Also, multiple trade ideas may be scored and ranked for a particular account as shown in FIG. 11. FIG. 11 is an exemplary illustration of multiple trade idea scores, according to an embodiment of the present invention. FIG. 11 illustrates trade scores which may be ranked by symbol 1110, industry 1112, region 1114, asset class 1116 and overall score 1118.

As shown in FIG. 11, for Trade ID 2, although BCA is not a symbol observed in the account transaction history, the strong presence of the other factor values (<Industry, Finance>, <Region, US>, and <Asset Class, Equity Listed>) may result in a strong recommendation score specific to this account. For Trade ID 3 (represented by HTT), although all factor values are present in the transaction history, their small values result in a relatively weaker recommendation score. FIG. 11 illustrates an example of a configuration. In accordance with the various embodiments of the present invention, trade idea scores are highly configurable and may vary based on various factors, preferences and applications.

For example, a score of zero for a specific trade idea's factor type may indicate that particular factor value has never before been observed in the account transaction history, while a score of one indicates that particular factor value is the only value that has ever been observed in the account transaction history. Other ranges and scores may be implemented.

According to another example, a score of zero for a target model may indicate that none of the factor values corresponding to the factor types defined for that model have been observed in the account transaction history while a score of one indicates that the factor values corresponding to a collection of factor types configured for the model are the only values ever observed in the account transaction history. Other ranges and scores may be implemented.

Under the Recommend component, an embodiment of the present invention may be directed to scoring trade idea match with an account profile. For each Trade Idea TI, the trade idea may be decomposed into the same (or similar) set of M-number of Factor types where keys represent Factor Types and values represent Factor Values.

An example trade idea is provided below:

$$Trade Idea \text{:} \{ \begin{matrix}〈 Symbol & XYZ 〉 \\ 〈 Industry & Transportation Services 〉 \\ 〈 Region & US 〉 \\ 〈 Asset Class & Equity Listed 〉\end{matrix}$$

Trade ideas may then be quantified by the vector w that holds the weight of each value in the distribution of factors:

wᵢ=P_{Factor i}(Value).

The quantitative model for generating relative rankings for trade ideas may include two additional specifications:

A vector, \vec{m} that provides the strength of each trading model in the output rankings. In this example, the total weight of the vector is unity; and

A matrix, C that specifies the linear combination of factors that make up trading models. In this example, the total weight of each row in the matrix is unity.

The illustration specifies the values,

$$\vec{m} = [ \begin{matrix}0.25 \\ 0.25 \\ 0.25 \\ 0.25\end{matrix} ] , \\ C = [ \begin{matrix}1.0 & 0.0 & 0.0 & 0.0 \\ 0.0 & 0.5 & 0.5 & 0.0 \\ 0.0 & 0.0 & 0.5 & 0.5 \\ 0.5 & 0.0 & 0.0 & 0.5\end{matrix} ] .$$

For each entry in the vector and matrix lie within the unit interval,

0≤mᵢ≤1, for all i,

0≤Cᵢⱼ≤, for all i, j,

Additionally, the sum of the vector and the sum of each row in the matrix are unity,

Σᵢmᵢ=ΣᵢCᵢⱼ=1.

Given the vectors, \vec{m} and \vec{w}, and the matrix, C, the trading recommendation, r, may be expressed as

r=\vec{m}^{T}·C·\vec{w},

In this example, the recommendation value may be bound by the unit interval, 0≤r≤1. Applying the model to a set of clients, which may be indexed by k, leads to a list of recommendation values, rₖ, that may be prioritized by sorting.

According to an embodiment of the present invention, the engine may incorporate a machine learning element which may take into account a client's response to recommendations, reflecting in changes to the target model weights, \vec{m}^{T}.

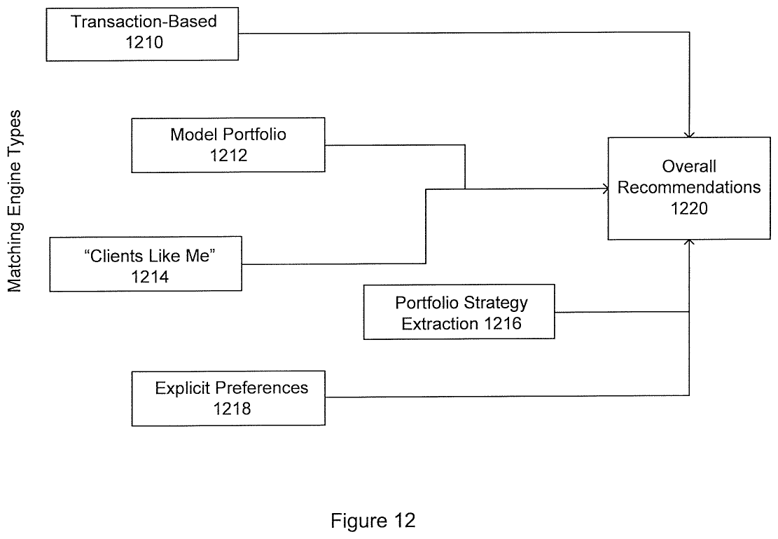

FIG. 12 is an exemplary illustration of matching engine types, according to an embodiment of the present invention. The features of the various embodiments of the present invention may be applied to other scenarios and areas relating to recommendations. Further enhancements may profiling of trading behavior and portfolio intent, as shown by 1212. The system may adapt the recommendation capability to learn a client's target portfolio (e.g., asset class allocations), shown by 1216, or preferred trading behavior (e.g., value investor, momentum trading, etc.), shown by 1218. Another feature may include a clients-like-me feature, shown by 1214, that generates additional recommendations based on client-centric recommendations in addition to transaction-centric recommendations, shown by 1210. Overall recommendations are represented by 1220.

Another enhancement may refer to online learning. This may incorporate real-time feedback on recommendations made to clients based upon generated scores. This feature enhancement may impact the weights associated with each target model as well as the composite factor type weights. Additionally, learning may indicate a need to shift factor value distributions to Boolean indicator variables based upon client portfolio holdings and transaction history, e.g., is more important to consider that the client has ever traded in some factor versus the proportion of trades in that same factor. Another enhancement may involve automated factor discovery that may utilize Machine Learning techniques to automatically select and weight the Factor Types most relevant to an account based upon transaction history. Also, normalize recommendation scores across accounts may score certain factor values more strongly due to the fact that there are fewer transactions in the account transaction history. For example, if an account has only 1,000 transactions, the distribution on symbols may be less than if an account has 10,000 transactions, resulting in an inherently higher symbol target model recommendation score for the account with less number of transactions. The system may also substitute input data by utilizing the same (or similar) transaction-centric recommendation framework but replace historical transactions with historical portfolio data.

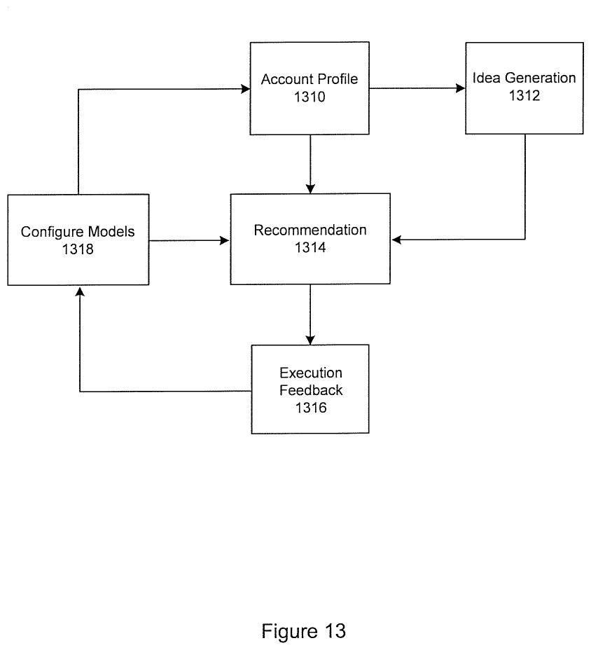

FIG. 13 is an exemplary flowchart illustrating an overall workflow, according to an embodiment of the present invention. In accordance with the various embodiments of the present invention, a User may refer to the end-user of the user interfaces; an Account may refer to a unique identifier for a collection of transactions; a Client may represent an owner of an account; and an Account Profile may represent a unique representation of the data associated with an account. According to an embodiment of the present invention, an Idea may refer to an idea for trade execution but may be abstracted to an idea for research, products, and other opportunities. FIG. 13 illustrates how various workflows interact, specifically Account Profile Workflow 1310, Idea Generation Workflow 1312, Recommendation Workflow 1314, Execution Feedback Workflow 1316 and Configure Models Workflow 1318. The details of each workflow are described below.

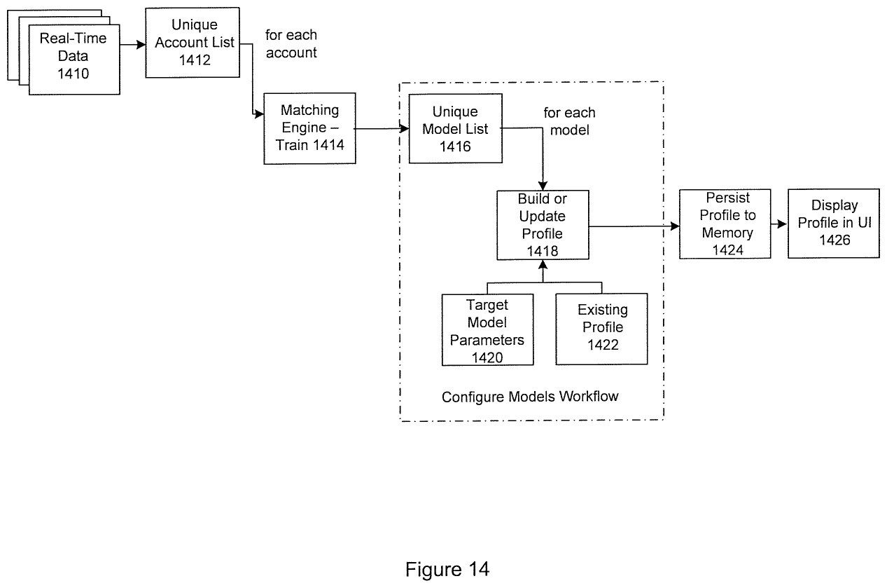

FIG. 14 is an exemplary flowchart illustrating an Account Profile Workflow, according to an embodiment of the present invention. At step 1410, Real-Time Data may be received. In this example, Real-Time Data may refer to a real-time record of all account-related data. At step 1412, a Unique Account List associated with the data may be obtained.

For each account, Matching Engine may initiate a Train procedure, as shown by step 1414. At step 1416, a list of models may be configured for the application. For each model, a profile may be built or updated, at step 1418. The new data point may be added to the profile of the associated account based on specified model parameters. The profile may include target model parameters, shown by 1420. Target model parameters may include a set of factors by which the data should be decomposed and added to profile. Existing Profile, shown by 1422, may be retrieved to be updated, if it exists; otherwise a new profile may be constructed. At 1424, the updated profile may be saved in memory for fast access (to update and view). At 1426, the profile (along the axes defined in the target model) may be visually displayed in user interface for users to view and manipulate.

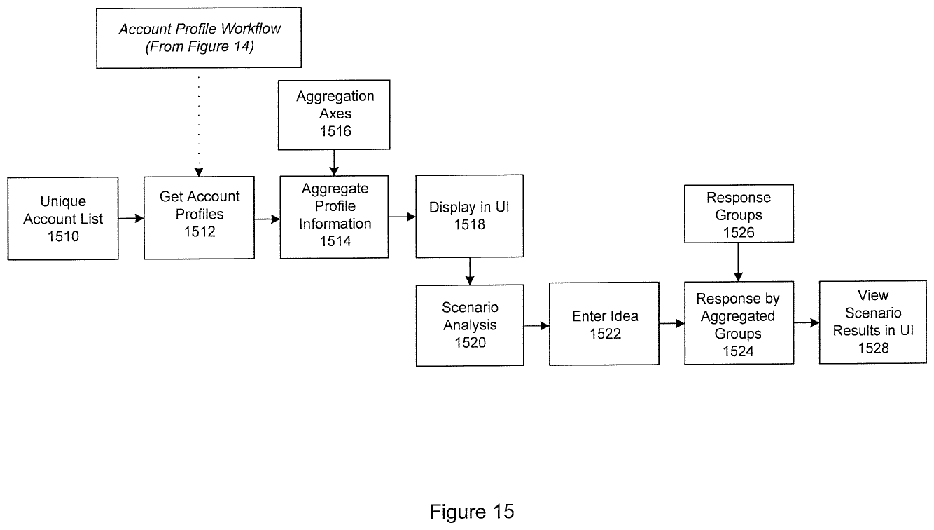

FIG. 15 is an exemplary flowchart illustrating an Idea Generation Workflow, according to an embodiment of the present invention. At step 1510, a set of unique accounts may be identified. At step 1512, the account profiles may be obtained for each account from Account Profile Workflow, as detailed in FIG. 14. At step 1514, the information from the account profiles may be aggregated into pre-defined axes. For example, pre-defined attributes may represent transactions grouped by symbol or country of exposure. As shown by 1516, axes by which to aggregate the account profiles may be used by step 1514. At step 1518, aggregation details may be displayed on a user interface. At step 1520, a scenario analysis may be initiated. At step 1522, a user may enter an idea into pre-defined fields, which may include asset class, symbol, maturity, rating where applicable, country of exposure, etc. At step 1524, the system may review a response to the proposed trade idea by defined response groups. For example, defined response groups may include clients in a geographic region, clients in a certain professional field, clients whom all hold similar securities, etc. As shown by 1526, pre-defined response groups may be received by step 1524. At step 1528, the response to the idea scenario may be displayed in a user interface. For example, information may include a number of possible clients interested in an idea, a number of clients affected by an idea based on their current positions, associated revenue implications given client buy-in, etc.

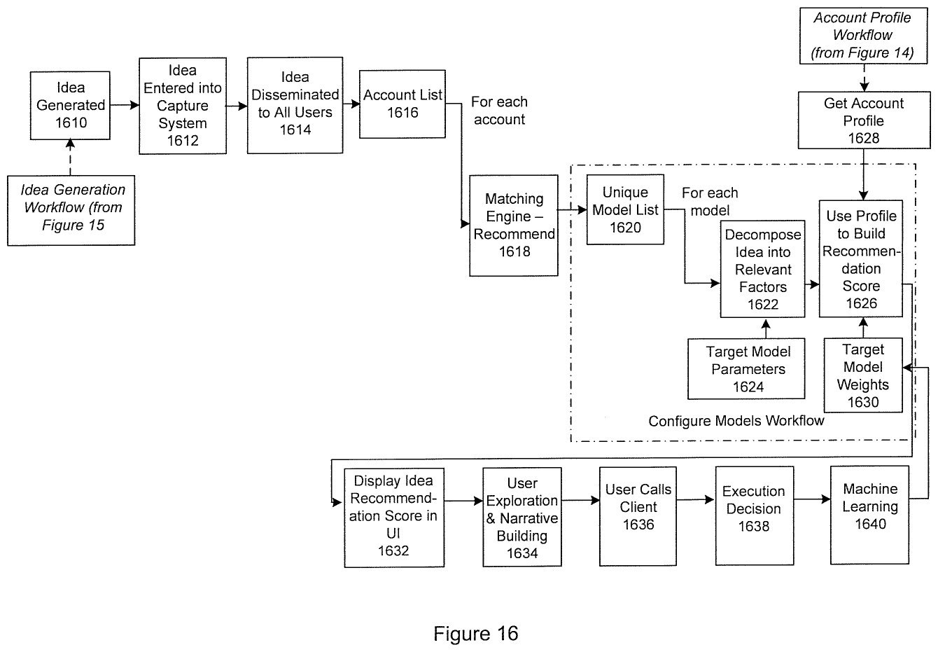

FIG. 16 is an exemplary flowchart illustrating a recommendation workflow, according to an embodiment of the present invention. At step 1610, an idea may be generated from Idea Generation Workflow, as detailed in FIG. 15. At step 1612, the idea may be entered into a Capture System. At step 1614, the idea may be disseminated to users. For example, once the idea is entered, users may receive a notification about the presence of the new idea. Other forms of communication may be implemented. At step 1616, a list of unique accounts within the system may be identified. For each account, a Matching Engine may initiate a Recommend process, at step 1618, for accounts within the system.

At step 1620, a set of models configured for the system may be identified. For each model, a new idea may be decomposed into constituent factors, at step 1622. As shown by 1624, a set of factors by which an idea should be decomposed may be received by 1622. At step 1626, the system may use a profile to build a recommendation score. For example, the system may join the decomposed idea with account profiles to generate an Account/Idea specific recommendation score. As shown by 1628, step 1626 may obtain the relevant profile from the Account Profile Workflow, as detailed in FIG. 14. As shown by 1630, Target Model Weights may be used to build a recommendation score. For example, Target Model Weights may include account-specific parameters which weigh the various factors based on significance.

At step 1632, recommendation scores may be displayed on a user interface. At step 1634, the user may explore top ranked accounts for an idea or vice versa. The user may also use the information displayed on user interface to build a comprehensive narrative for why the account should execute the idea. At step 1636, the user may communicate with a client using the informed narrative. For example, the user may call the client to initiate a discussion on executing the recommended idea. The user may also send an electronic communication or connect with the client via a social media or other network. At step 1638, the client may choose to execute the idea. At step 1640, a machine learning process may be initiated to determine whether or not the idea executed will inform the significance of respective target model weights.

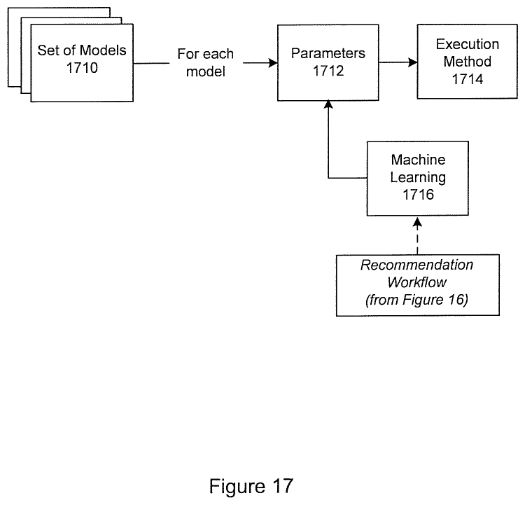

FIG. 17 is an exemplary flowchart illustrating a configure models workflow, according to an embodiment of the present invention. At step 1710, a Set of Models may be defined. For each model, the following steps may be performed. At step 1712, parameters for the model may be defined. For example, parameters may include a set of target factors and associated target factor weights. At step 1714, an execution method for the model may be defined. For example, the execution method may segment a transaction history by the given parameters and then overlay a new trade idea. At step 1716, feedback from a Recommendation Workflow, as shown at 1718, may update the parameters associated with a model. This may occur via Machine Learning or other artificial intelligence. For example, client decisions to execute a trade may update the target factors weights. The details of Recommendation Workflow are illustrated in FIG. 16.

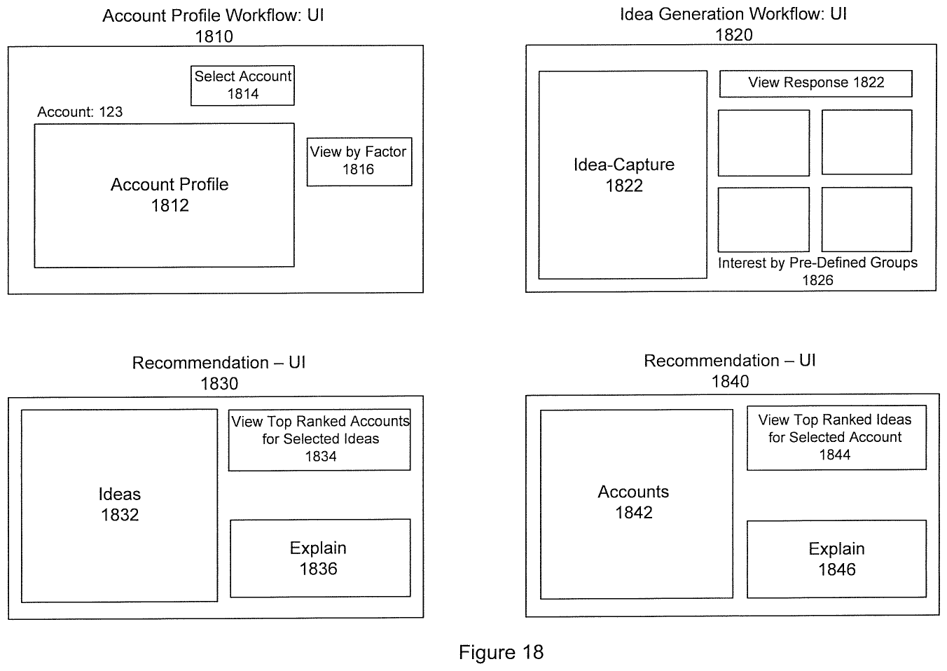

FIG. 18 are exemplary screenshots of workflows, according to an embodiment of the present invention. 1810 illustrates an Account Profile Workflow. User Interface 1810 may include an Account Profile display at 1812, Select Account 1814 and View by Factor 1816. 1820 illustrates an Idea Generation Workflow. User Interface 1820 may include an Idea-Capture display at 1822, View Response 1824 and Interest by Pre-Defined Groups 1826. 1830 illustrates a Recommendation Workflow. User Interface 1830 may include an Ideas display at 1832, View Ranked Accounts 1834 and Explain 1836. 1840 illustrates another exemplary Recommendation Workflow. User Interface 1840 may include an Account display at 1842, View Ranked Accounts 1844 and Explain 1846.

The user interfaces illustrated in FIG. 18 are exemplary. Other variations and information may be provided.

The foregoing examples show the various embodiments of the invention in one physical configuration; however, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

As described above, FIG. 1 includes a number of communication devices and components, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software.

It is appreciated that in order to practice the methods of the embodiments as described above, it is not necessary that the processors and/or the memories be physically located in the same geographical place. That is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

As described above, a set of instructions is used in the processing of various embodiments of the invention. The servers in FIG. 1 may include software or computer programs stored in the memory (e.g., non-transitory computer readable medium containing program code instructions executed by the processor) for executing the methods described herein. The set of instructions may be in the form of a program or software or app. The software may be in the form of system software or application software, for example. The software might also be in the form of a collection of separate programs, a program module within a larger program, or a portion of a program module, for example. The software used might also include modular programming in the form of object oriented programming. The software tells the processor what to do with the data being processed.

Further, it is appreciated that the instructions or set of instructions used in the implementation and operation of the invention may be in a suitable form such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, i.e., to a particular type of computer, for example. Any suitable programming language may be used in accordance with the various embodiments of the invention. For example, the programming language used may include assembly language, Ada, APL, Basic, C, C++, COBOL, dBase, Forth, Fortran, Java, Modula-2, Pascal, Prolog, REXX, Visual Basic, and/or JavaScript. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of various embodiments of the invention may utilize any compression or encryption technique or algorithm, as may be desired. An encryption module might be used to encrypt data. Further, files or other data may be decrypted using a suitable decryption module, for example.

In the system and method of exemplary embodiments of the invention, a variety of “user interfaces” may be utilized to allow a user to interface with the mobile devices 120, 130 or other personal computing device. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

The software, hardware and services described herein may be provided utilizing one or more cloud service models, such as Software-as-a-Service (SaaS), Platform-as-a-Service (PaaS), and Infrastructure-as-a-Service (IaaS), and/or using one or more deployment models such as public cloud, private cloud, hybrid cloud, and/or community cloud models.

Although, the examples above have been described primarily as using a software application (“app”) downloaded onto the customer's mobile device, other embodiments of the invention can be implemented using similar technologies, such as transmission of data that is displayed using an existing web browser on the customer's mobile device.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

1. A computer implemented system that generates client profile-based recommendations, the engine comprising:
an interactive interface that receives user input;
a database that stores and manages historical client transaction data; and
a computer processor, coupled to the interactive interface and the database, programmed to:
collect and assimilate real-time data relating to a plurality of accounts associated with a plurality of users from a plurality of sources;
develop a plurality of target models, where each target model has a set of factors and corresponding weights, based on the real-time data;
build an account profile, wherein the account profile reflects a client's trading behavior, by implementing a machine learning process to automatically determine specific factors and factor weights for the plurality of target models based upon the historical client transaction data;
identify a plurality of trade ideas by applying the plurality of target models for the account profile to the historical client transaction data;
decompose the plurality of trade ideas based on the account profile's specific factors and weights as associated with the plurality of target models;
determine scores for each trade idea based on a factor value distribution score multiplied by the factor type weight of the account profile;
rank trade ideas based on the scores;
electronically transmit, via the interactive interface, ranked trade ideas to a user; and
apply machine learning to improve the client profile-based recommendations by incorporating real-time feedback on the client profile-based recommendations to refine the factor weights.

2. The engine of claim 1, wherein the target models comprise a combination of descriptive transaction attributes.

3. The engine of claim 1, wherein decomposing trade ideas comprises representing a trade idea into one or more descriptive attributes.

4. The engine of claim 1, wherein the account profile is based on target model parameters and an existing profile.

5. The engine of claim 1, wherein machine learning is applied to refine the account profile.

6. The engine of claim 1, wherein machine learning is applied to update one or more parameters associated with a target model.

7. The engine of claim 1, wherein the user communicates a trade opportunity based on the ranked trade ideas to one or more clients.

8. The engine of claim 1, wherein the user is a financial advisor.

9. The engine of claim 1, comprising a train component that captures behavior for a given account and a recommend component that calculates a recommendation score.

10. The engine of claim 1, wherein the scores represent a frequency value for each factor of the trade idea multiplied by a weight defined in a target model.

11. A computer implemented method that generates client profile-based recommendations, the method comprising the steps of:
collecting and assimilating real-time data relating to a plurality of accounts associated with a plurality of users from a plurality of sources;
developing, via an engine comprising a computer processor, a plurality of target models, where each target model has a set of factors and corresponding weights, based on the real-time data;
building, via the engine, an account profile, wherein the account profile reflects a client's trading behavior, by implementing a machine learning process to automatically determine specific factors and factor weights for the plurality of target models based upon the historical client transaction data;
identifying a plurality of trade ideas by applying the plurality of target models for the account profile to the historical client transaction data;
decomposing, via the engine, the plurality of trade ideas based on the account profile's specific factors and weights as associated with the plurality of target models;
determining, via the engine, scores for each trade idea based on a factor value distribution score multiplied by the factor type weight of the account profile;
ranking, via the engine, trade ideas based on the scores;
electronically transmitting, via an interactive interface, ranked trade ideas to a user; and
applying machine learning to improve the client profile-based recommendations by incorporating real-time feedback on the client profile-based recommendations to refine the factor weights

12. The method of claim 11, wherein the target models comprise a combination of descriptive transaction attributes.

13. The method of claim 11, wherein decomposing trade ideas comprises representing a trade idea into one or more descriptive attributes.

14. The method of claim 11, wherein the account profile is based on target model parameters and an existing profile.

15. The method of claim 11, wherein machine learning is applied to refine the account profile.

16. The method of claim 11, wherein machine learning is applied to update one or more parameters associated with a target model.

17. The method of claim 11, wherein the user communicates a trade opportunity based on the ranked trade ideas to one or more clients.

18. The method of claim 11, wherein the user is a financial advisor.

19. The method of claim 11, comprising a train component that captures behavior for a given account and a recommend component that calculates a recommendation score.

20. The method of claim 11, wherein the scores represent a frequency value for each factor of the trade idea multiplied by a weight defined in a target model.
